(19) United States
(12) Patent Application Publication
(10) Pub. No.: US 2018/0076449 A1
(43) Pub. Date: Mar. 15, 2018

(54) NEGATIVE ELECTRODE FOR LITHIUM ION SECONDARY BATTERY AND SECONDARY BATTERY

(71) Applicant: NEC CORPORATION, Tokyo (JP)

(72) Inventors: Jiro IRIYAMA, Tokyo (JP); Ikiko SHIMANUKI, Tokyo (JP); Takeshi AZAMI, Tokyo (JP)

(21) Appl. No.: 15/560,360

(22) PCT Filed: Mar. 17, 2016
(86) PCT No.: PCT/JP2016/058493

§ 371 Date: Sep. 21, 2017

(30) Foreign Application Priority Data
Mar. 24, 2015 (JP) 2015-061349

(51) Int. Cl. H01M 4/36; H01M 10/0525; H01M 4/131; H01M 4/133; H01M 4/1391; H01M 4/1393; H01M 4/485; H01M 4/583; H01M 4/04; H01M 10/058

(52) U.S. Cl. CPC H01M 4/364; H01M 10/0525; H01M 4/131; H01M 4/133; H01M 4/1391; H01M 2220/20; H01M 4/485; H01M 4/583; H01M 4/366; H01M 4/0404; H01M 10/058; H01M 4/1393

(57) ABSTRACT

A negative electrode for a lithium ion secondary battery is disclosed, which comprises, as active materials, (a) at least one material selected from metals capable of forming an alloy with lithium and metal oxides capable of absorbing and desorbing lithium ions (hereinafter referred to as metal and/or metal oxide), and (b) a surface-coated carbon material capable of absorbing and desorbing lithium ions; wherein, an average value of circularity of the metal and/or metal oxide particles defined by following formula (1) is 0.78 or more;

Circularity=4πS/L² (1)

wherein S is an area of a projected image of particle and L is a circumferential length of the projected image of particle. The lithium ion secondary battery having this electrode has improved cycle characteristics.

### TECHNICAL FIELD

The present invention relates to a lithium ion secondary battery, and more particularly to a negative electrode capable of forming a lithium ion secondary battery excellent in characteristics, a method of manufacturing the same, and a vehicle and a power storage system, using the lithium ion secondary battery.

### BACKGROUND ART

Lithium ion secondary batteries are characterized by their small size and large capacity and are widely used as power sources for electronic devices such as mobile phones and notebook computers, and have contributed to the improvement of the convenience of portable IT devices. In recent years, attention has also been drawn to the use in large-sized applications such as drive power supplies for motorcycles and automobiles, and storage batteries for smart grids. As the demand for lithium ion secondary batteries has increased and they are used in various fields, batteries have been required to have characteristics, such as further higher energy density, lifetime characteristics that can withstand long-term use, and usability under a wide range of temperature conditions.

Carbon-based materials such as graphite are generally used for the negative electrode of the lithium-ion secondary battery, but in order to increase the energy density of the battery, a negative electrode containing metal particles such as silicon or oxide particles such as silicon oxide in addition to the carbon material particles, has been proposed (see, for example, Patent Document 1: Japanese Patent Laid-Open Publication No. 2003-128740).

Since graphite having high crystallinity has high decomposition activity to electrolyte solution, a particle whose surface is coated with, for example, amorphous carbon is frequently used (for example, Patent Document 2: Japanese Patent Laid-Open Publication No. 2010-97696).

### CITATION LIST

### Patent Document

Patent Document 1: Japanese Patent Laid-Open Publication No. 2003-123740

Patent Document 2: Japanese Patent Laid-Open Publication No. 2010-97696

Patent Document 3: Japanese Patent Laid-Open Publication No. 2014-225347

### SUMMARY OF INVENTION

### Technical Problem

In the negative electrode containing graphite and a silicon-based material as in Patent Document 1, there is a problem that the silicon-based material exhibits particularly large volume changes due to charging and discharging, and the negative electrode deteriorates as charging and discharging are repeated, which affects the cycle characteristics of the battery. Further, when graphite having surface coating as described in Patent Document 2 is used alone, cycle characteristics are improved, but when used together with a silicon-based material for a negative electrode, there is a case in which the improvement is not observed to an expected extent. In addition, Patent Document 3 describes a technique of using silicon oxide having a high degree of circularity as a negative electrode material but there is no description about joint use with a surface-coated carbon material.

An embodiment of the present invention provides a negative electrode for a lithium ion secondary battery having excellent cycle characteristics by using a metal and/or a metal oxide, which are typically silicon-based materials, and a surface-coated carbon material as active materials.

### Solution to Problem

One embodiment of the present invention relates to a negative electrode for a lithium ion secondary battery, comprising, as active materials, (a) at least one material selected from metals capable of forming an alloy with lithium and metal oxides capable of absorbing and desorbing lithium ions (hereinafter referred to as metal and/or metal oxide), and

(b) a surface-coated carbon material capable of absorbing and desorbing lithium ions,

wherein, an average value of circularity of the metal and/or metal oxide particles defined by following formula (1):

Circularity=4πS/L² (1)

wherein S is an area of a projected image of particle and L is a

circumferential length of the projected image of particle;

is 0.78 or more.

### Advantageous Effect of Invention

According to an embodiment of the present invention, there is provided a lithium ion secondary battery having improved cycle characteristics.

### BRIEF DESCRIPTION OF DRAWING

FIG. 1 is a cross-sectional view schematically showing an example of a stacked electrode element.

FIG. 2 shows an exploded perspective view showing a basic structure of a film package battery.

FIG. 3 shows a schematic cross-sectional view showing the cross-section of the battery of FIG. 2.

### DESCRIPTION OF EMBODIMENTS

Metals and metal oxides that have been used conventionally are generally obtained by pulverizing lumps, so that the particles have sharp corners and are harder than carbon materials such as graphite. Therefore, when metal or a metal oxide particles are mixed with surface-coated carbon particles at the time of manufacturing the electrode, it is considered that the surface coating of the carbon particles is damaged by the sharp corner of the metal or the metal oxide particles, which causes peeling and reduces the effect of the surface coating. Also in the charge and discharge cycles, it is considered that the surface coating of the carbon particles is damaged because the metal and metal oxide particles exhibit large volume changes.

In the present embodiment, it is presumed that the cycle characteristics have been improved because the metal or metal oxide particles do not have a sharp corner, the surface coating of the carbon particles is not damaged or even if it is damaged, it is smaller than the conventional case.

Hereinafter, embodiments of the present invention will be described for each constituting member of the lithium secondary battery.

<Negative Electrode>

The negative electrode has a structure in which a negative electrode active material is laminated on a current collector as a negative electrode active material layer integrated by a negative electrode binder. The negative electrode active material is a material capable of reversibly absorbing and desorbing lithium ions with charge and discharge.

The negative electrode of the present embodiment includes, as active materials, (a) at least one material selected from metals capable of forming an alloy with lithium and metal oxides capable of absorbing and desorbing lithium ions, and (b) a surface-coated carbon, material capable of absorbing and desorbing lithium ions.

In the present embodiment, “(a) material selected from metals capable of forming an alloy with lithium and metal oxides capable of absorbing and desorbing lithium ions” may be used by selecting one or more materials from either one of these or may be used in combination by selecting one or more materials from both of these. Hereinafter, “at least one material selected from metals capable of forming an alloy with lithium and metal oxides capable of absorbing and desorbing lithium ions” may be referred to as “metal and/or metal oxide”, and when describing “metal capable of forming an alloy with lithium” and “metal oxide capable of absorbing and desorbing lithium ions”, they may be collectively referred to as “metal and metal oxide” in some cases.

“Metal and metal oxides” are in forms of particle and have shapes having no sharp corner. As will be described later, when the metal is dispersed inside of the metal oxide, it is sufficient that the metal oxide forming the outer shape of the particle has the prescribed shape.

When the shape of the projected image of the metal and metal oxide particles is expressed by using circularity (i.e. roundness) as an index, the average circularity (number average) is 0.78 or more, preferably 0.8 or more, and more preferably 0.85 or more. Here, the circularity is defined by the following equation.

Circularity=4πS/L²

wherein S is an area of a projected image of particle and L is a circumferential length of the projected image of particle.

The method of measuring the circularity of the particles is not particularly limited, but it can be obtained, for example, by carrying out image processing on projected images of 500 arbitrary particles using a powder image analyzer, if the measuring is carried out before manufacturing the negative electrode. As a powder image analyzer, for example, Microtrac FPA (trade name) manufactured by Nikkiso Co., Ltd., PITA-3 manufactured by Seishin Enterprise Co., Ltd., and the like can be used. In addition, if the measuring is carried out after manufacturing the negative electrode, it can be obtained by performing image processing on arbitrary 100 particles from the negative electrode cross section photograph using SEM (scanning electron microscope).

Examples of metals capable of forming an alloy with lithium include Al, Si, Pb, Sn, In, Bi, Ag, Ba, Ca, Hg, Pd, Pi, Te, Zn, La, and alloys of two or more of these. In particular, it is preferred that silicon (Si) is contained as a metal capable of forming an alloy with lithium. The content of the metal in the negative electrode active material is preferably 5% by mass or more and 95% by mass or less, more preferably 10% by mass or more and 90% by mass or less, and further more preferably 20% by mass or more and 50% by mass or less.

Examples of the metal oxide capable of absorbing and desorbing lithium ions include aluminum oxide, silicon oxide, tin oxide, indium, oxide, zinc oxide, lithium oxide, and composites of these. In particular, it is preferable that a silicon oxide as a metal oxide capable of absorbing and desorbing lithium ions is contained. It is also possible to add one or more elements selected from nitrogen, boron, phosphorus and sulfur to the metal oxide. This can improve the electrical conductivity of the metal oxide. The content of the metal oxide in the negative electrode active material may be 0% by mass or 100% hy mass, but it is preferably 5% by mass or more and 100% by mass or less, more preferably 40% by mass or more and 95% by mass or less, and even more preferably 50% by mass or more and 90% by mass or less.

In the present embodiment, it is preferable that at least Si and/or silicon oxide is contained as a negative electrode active material. The composition of the silicon oxide is represented by SiOx (where 0<x≦2). A particularly preferred silicon oxide is SiO.

Further, it is preferable that all or part of the metal oxide has an amorphous structure. The metal oxide having an amorphous structure can suppress volume change of other negative electrode active material such as a metal capable of forming an alloy with lithium and a carbon material capable of absorbing and desorbing lithium ions, or suppress the decomposition of the electrolyte solution. Although this mechanism is not clear, it is presumed that the metal oxide having an amorphous structure may give some influence on the film formation on the interface between the carbon material and the electrolyte solution. Further, the amorphous structure is considered to have relatively few nonuniformity-associated elements, such as crystal grain boundaries and defects. The fact that all or a part of the metal oxide has an amorphous structure can be confirmed by X-ray diffraction measurement (general XRD measurement). Specifically, when the metal oxide does not have an amorphous structure, a peak characteristic to the metal oxide is observed, but in the case where all or a part of the metal oxide has an amorphous structure, a peak characteristic to metal oxide is observed as a broad peak.

Further, in the case where the negative electrode active material contains a metal capable of forming an alloy with lithium and a metal oxide capable of absorbing and desorbing lithium ions, it is preferred that all or some of the alloy able metals are dispersed inside of the metal oxide. This can suppress the volume change of the whole negative electrode, and can suppress the decomposition of the electrolyte solution. The fact that all or a part of the metal is dispersed inside of the metal oxide can be confirmed by observation by the combination of transmission electron microscope (general TEM observation) and energy dispersive X-ray spectroscopic measurement (general EDX measurement). Specifically, the fact that the metal constituting the metal particles is not oxidized can be confirmed by observing the cross section of the sample containing the metal particles, and measuring the oxygen concentration of the metal particles dispersed inside of the metal oxide.

When the negative electrode active material contains both a metal and a metal oxide, the metal oxide is preferably an oxide of a metal constituting the metal.

When the negative electrode active material contains both a metal and a metal oxide, there is no particular limitation on the ratio of the metal and the metal oxide. The content of the metal is preferably 5% by mass or more and 90% by mass or less, and more preferably 30% by mass or more and 60% by mass or less, based on the total mass of the metal and the metal oxide. The content of the metal oxide is preferably 10% by mass or more and 95% by mass or less, and more preferably 40% by mass or more and 70% by mass or less, based on the total mass of the metal and the metal oxide.

The surface of the metal and metal oxide particles may be coated with a carbon material (usually amorphous carbon material). Methods of coating particles include a method of chemical vapor deposition (CVD) in an organic gas and/or vapor. Also, the surfaces of the metal and metal oxide particles may be coated with a metal oxide coating. As the metal oxide coating film, an oxide of one or more elements selected from magnesium, aluminum, titanium and silicon are preferable. In addition to the above elements, it may contain at least one element selected from the group consisting of zirconium, hafnium, vanadium, niobium, tantalum, chromium, molybdenum, tungsten, manganese, iron, ruthenium, cobalt, rhodium, iridium, nickel, palladium, cerium, indium, germanium, tin, bismuth, antimony, cadmium, copper, and silver. In this case, the surface of the metal oxide coating may be further coated with a carbon material (usually an amorphous carbon material).

In general, the metal, and metal oxide particles covered with a carbon material can provide a secondary battery having excellent cycle characteristics.

Next, “(b) surface-coated carbon material capable of absorbing and desorbing lithium ions” is a material in which the surface of a carbon material capable of absorbing and desorbing lithium ions used as an active material of a negative electrode is coated with a coating material. Examples of such carbon materials include graphite, amorphous carbon, diamond-like carbon, carbon nanotube, and a composite of these. Among these, graphite has high crystallinity and high electric conductivity, and is excellent in adhesion to a current collector made of a metal such as copper and in flatness of voltage.

As a graphite, any of natural graphite and artificial graphite may be used. The shape of the graphite is not particularly limited and may be any shape. Examples of the natural graphite include flake-like (scaly) graphite, flake-like graphite, earthy graphite and the like, and examples of the artificial graphite include massive artificial graphite, flake-like artificial graphite, and spherical artificial graphite such as MCMB (mesophase microbeads).

Examples of the coating material for coating the surface of the carbon material as the active material include a carbon material (usually an amorphous carbon material), a metal, a metal oxide, and the like. In the present embodiment, coated graphite is particularly preferred, and amorphous carbon is typically used as a coating material. As a method of coating the surface of the graphite particle with amorphous carbon, a method of chemical vapor deposition (CVD) in an organic gas and/or vapor can be used. Coating amount of amorphous carbon is about 0.5 to 20% by mass, preferably 3% by mass to 15% by mass, based on an amount of particles to be coated.

The coverage of the surface-coated carbon material is preferably 50 to 100%, more preferably 70 to 100%, and most preferably 90 to 100%. Here, the coverage is a percentage of the surface of the carbon material of the base material on which the coating material exists. Specifically, the coverage can be obtained by analyzing the surface of the carbon material and calculating the ratio of the area in which the index unique to the coating material is observed. For example, in the case of amorphous carbon-coated graphite, D peak observed in the range of 1300 cm⁻¹ to 1400 cm⁻¹ in Raman spectroscopy is assigned to amorphous carbon, and G peak observed in the range of 1550 cm⁻¹ to 1650 cm⁻¹ is assigned to crystalline carbon. Therefore, by analyzing minute spots (spot diameter 1 μm or less) on the surface of the coated carbon material by Raman spectroscopy, the coverage can be calculated from the number of spots showing the D/G ratio (D is the peak intensity of the D peak and G is the peak intensity of the G peak) characteristic to the amorphous carbon and the number of spots showing the D/G ratio characteristic to the graphite of the base material. When amorphous carbon is formed by CVD, the coverage becomes approximately 100% when the coating amount is about 3% by mass.

In the present embodiment, the particle diameter of “metal and metal oxide” and “carbon material” is not particularly limited, but the median diameter (D50 particle diameter) of the metal and metal oxide particles is preferably about 1 to 30 μm, and the median diameter (D50 particle diameter) of the carbon material is preferably about 5 to 50 μm.

Also, it is preferable that the median diameter of the metal and metal oxide particles is smaller than the median diameter of the carbon material. This allows that the metal and the metal oxide having a large volume change accompanied with charging and discharging become to have relatively small particle size and the carbon material having small volume change becomes to have relatively large particle size, so that dendrite formation and the pulverization of the negative electrode material are suppressed more effectively.

In the present embodiment, the content of the metal and the metal oxide in the negative electrode is preferably 1 to 20% by mass, more preferably 1 to 10% by mass, based on the total amount of the metal, the metal oxide and the carbon material.

Examples of the negative electrode binder include polyvinylidene fluoride, modified polyvinylidene fluoride, vinylidene fluoride-hexafluoropropylene copolymer, vinylidene fluoride-tetrafluoroethylene copolymer, styrene-butadiene copolymer rubber, polytetrafluoroethylene, polypropylene, polyethylene, polyacrylic acid, metal salts of polyacrylic acid, polyimide, polyamideimide, and the like. When an aqueous binder such as an SBR emulsion is used, a thickener such as carboxymethyl cellulose (CMC) may also be used.

In the present embodiment, the negative electrode hinder preferably comprises a binder selected from polyimide, polyamideimide, polyacrylic acid and metal salts of polyacrylic acid. The amount of the negative electrode binder is preferably 0.5 to 20% by mass based on the total mass of the negative electrode active material, from the viewpoint of “sufficient binding strength” and “high energy density” being in a trade-off relation with each other.

The negative electrode active material may be used together with a conductive assisting agent as required. Specific examples of the conductive assisting agent are the same as those specifically exemplified in the following positive electrode, and the usage amount thereof may be the same as well.

As the negative electrode current collector, from the view point of electrochemical stability, aluminum, nickel, copper, silver, and alloys thereof are preferred. As the shape thereof, foil, flat plate, mesh and the like are exemplified.

As a manufacturing method of the negative electrode, for example, a negative electrode active material, if required, a conductivity imparting agent, and a binder are dispersed and kneaded in a solvent such as N-methyl-2-pyrrolidone (NMP) to prepare a negative electrode slurry. The negative electrode slurry is coated on a negative electrode current collector such as a copper foil, and the solvent is dried to prepare a negative electrode layer. Examples of the coating method include a doctor blade method and a die coater method. It is also possible that, after forming the negative electrode active material layer in advance, a thin film of aluminum, nickel or an alloy thereof may be formed by a method such as vapor deposition, sputtering or the like to obtain a negative electrode current collector. A desired heat treatment may be performed as required, for example in the case where heat treatment at a temperature equal to or higher than the temperature necessary to dry solvents is required, such as the cases where a polyimide precursor or a poly amide-imide precursor is used. The polyamide precursor or the polyimide precursor is preferably comprises a polyamic acid. Further, a negative electrode before lithium, pre-doping may be fabricated, by forming a negative electrode active material or the like on a negative electrode current collector by a gas phase growth method such as vapor deposition or sputtering.

In the present embodiment, since the circularity of the metal and the metal oxide particles are large, even if the negative electrode slurry is prepared by kneading together with the coated carbon material and the negative electrode layer is formed by using this material, it is considered that the coating material of the coated carbon material is hardly damaged; and thus, the battery characteristics, in particular, the cycle characteristics are improved.

<Positive Electrode>

The positive electrode includes a positive electrode active material capable of reversibly absorbing and desorbing lithium ions with charge and discharge and it has a structure in which the positive electrode active material is laminated on a current collector as a positive electrode active material layer integrated by a positive electrode binder.

The positive electrode active material in the present embodiment is not particularly limited as long as it is a material capable of absorb and desorb lithium, but from the viewpoint of high energy density, a compound having high capacity is preferably contained. Examples of the high capacity compound include lithium nickelate (LiNiO₂), or lithium nickel composite oxides in which a part of the Ni of lithium nickelate is replaced by another metal element, and layered lithium nickel composite oxides represented by the following formula (A) are preferred.

Li_{y}Ni₍₁₋ₓ₎MₓO₂ (A)

wherein 0≦x<1, 0<y≦1.2, and M is at least one element selected from the group consisting of Co, Al, Mn, Fe, Ti, and B.

In addition, from, the viewpoint of high capacity, it is preferred that the content of Ni is high, that is, x is less than 0.5 further preferably 0.4 or less in the formula (A). Examples of such compounds include Li_{α}Ni_{β}Co_{γ}Mn_{δ}O₂ (0<α≦1.2 preferably 1≦α≦1.2, β+γ+δ=1, β≧0.7, and γ≦0.2) and Li_{α}Ni_{β}Co_{γ}Al_{δ}O₂ (0<α≦1.2, preferably 1≦α≦1.2, β+γ+δ=1, β≧0.6, preferbly β≧0.7, and γ≦0.2) and particularly include LiNi_{β}Co_{γ}Mn_{δ}O₂ (0.75≦β≦0.85, 0.05≦γ0.15, and 0.10≦δ≦0.20). More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, and LiNi_{0.8}Co_{0.1}Al_{0.1}O₂ may be preferably used.

From, the viewpoint of thermal stability, it is also preferred that the content of Ni does not exceed 0.5, that is, x is 0.5 or more in the formula (A). In addition, it is also preferred that particular transition metals do not exceed half. Examples of such compounds include Li_{α}Ni_{β}Co_{γ}Mn_{δ}O₂ (0<γ≦1.2, preferably 1≦α≦1.2, β+γδ=1, 0.2≦β≦0.5, 0.1≦γ≦0.4, and 0.1≦γ≦0.4). More specific examples may include LiNi_{0.4}Co_{0.3}Mn_{0.3}O₂ (abbreviated as NCM433), LiNi_{1/3}Co_{1/3}Mn_{1/3}O₂, LiNi_{0.5}Co_{0.2}Mn_{0.3}O₂ (abbreviated as NCM523), and LiNi_{0.5}Co_{0.3}Mn_{0.2}O₂ (abbreviated as NCM532) (also including those in which the content of each transition metal fluctuates by about 10% in these compounds).

In addition, two or more compounds represented by the formula (A) may be mixed and used, and, for example, it is also preferred that NCM532 or NCM523 and NCM433 are mixed in the range of 9:1 to 1:9 (as a typical example, 2:1) and used. Further, by mixing a material in which the content of Ni is high (x is 0.4 or less in the formula (A)) and a material in which the content of Ni does not exceed. 0.5 (x is 0.5 or more, for example, NCM433), a battery having high capacity and high thermal stability can also be formed.

Examples of the positive electrode active materials other than the above include lithium manganate having a layered structure or a spinel structure such as LiMnO₂, LiₓMn₂O₄ (0<x<2), Li₂MnO₃, and LiₓMn_{1.5}Ni_{0.5}O₄ (0<x<2) LiCoO₂ or materials in which, a part of the transition metal in this material is replaced by other metal(s); materials in which Li is excessive as compared with the stoichiometric composition in these lithium transition metal oxides; materials having olivine structure such as LiMPO₄, and the like. In addition, materials in which a part of elements in these metal oxides is substituted by Al, Fe, P, Ti, Si, Pb, Sn, In, Bi, Ag, Ba, Ca, Hg, Pd, Pt, Te, Zn, La are also usable. The positive electrode active materials described above may be used alone or in combination of two or more.

As the positive electrode binder, the same binder as the negative electrode binder can be used. Among them, polyvinylidene fluoride or polytetrafluoroethylene is preferable from the viewpoint of versatility and low cost, and polyvinylidene fluoride is more preferable. The amount of the positive electrode binder is preferably 2 to 10 parts by mass based, on 100parts by mass of the positive electrode active material, from the viewpoint of the binding strength and energy density that are in a trade-off relation with each other.

For the coating layer containing the positive electrode active material, a conductive assisting agent may be added for the purpose of lowering the impedance. Examples of the conductive assisting agent include, flake-like, soot, and fibrous carbon fine particles and the like, for example, graphite, carbon black, acetylene black, vapor grown carbon fibers (for example, VGCF manufactured by Showa Denko) and the like.

As the positive electrode current collector, the same material as the negative electrode current collector can be used. In particular, as the positive electrode, a current collector using aluminum, an aluminum alloy, or iron-nickel-chromium-molybdenum based stainless steel is preferable.

Similar to the negative electrode, the positive electrode may be prepared by forming a positive electrode active material layer containing a positive electrode active material and a binder for positive electrode on a positive electrode current collector.

<Electrolyte Solution>

The electrolyte solution of the lithium ion secondary battery according to the present embodiment is not particularly limited, but is preferably a nonaqueous electrolyte solution containing a nonaqueous solvent and a supporting salt that is stable at the operating potential of the battery.

Examples of nonaqueous solvents include aprotic organic solvents, for examples, cyclic carbonates such as propylene carbonate (PC), ethylene carbonate (EC) and butylene carbonate (BC); open-chain carbonates such as dimethyl carbonate (DMC), diethyl carbonate (DEC), ethyl methyl carbonate (EMC) and dipropyl carbonate (DPC); aliphatic carboxylic acid esters such as propylene carbonate derivatives, methyl formate, methyl acetate and ethyl propionate; ethers such as diethyl ether and ethyl propyl ether; phosphoric acid esters such as trimethyl phosphate, triethyl phosphate, tripropyl phosphate, trioctyl phosphate and triphenyl phosphate; and fluorinated aprotic organic solvents obtainable by substituting at least a part of the hydrogen atoms of these compounds with fluorine atom(s), and the like.

Among them, cyclic or open-chain carbonate(s) such as ethylene carbonate (EC), propylene carbonate (PC), butylene carbonate (BC), dimethyl carbonate (DMC), diethyl carbonate (DEC), ethyl methyl carbonate (MEC), dipropyl carbonate (DPC) and the like is preferably contained.

Nonaqueous solvent may be used alone, or in combination of two or more.

The examples of lithium salts include LiPF₆, LiAsF₆, LiAlCl₄, LiClO₄, LiBF₄, LiSbF₆, LiCF₈SO₈, LiC₄F₉SO₃, LiC(CF₈SO₂)₃, LiN(CF₈SO₂)₂ and the like. Supporting salts may be used alone or in combination of two or more. From the viewpoint of cost reduction, LiPF₆ is preferable.

The electrolyte solution may further contain additives. The additive is not particularly limited, and examples thereof include halogenated cyclic carbonates, unsaturated cyclic carbonates, cyclic or open-chain disulfonic acid esters, and the like. The addition of these compounds improves battery characteristics such as cycle characteristics. This is presumably because these additives decompose during charging and discharging of the lithium ion secondary battery to form a film on the surface of the electrode active material and inhibit decomposition of the electrolyte solution and supporting salt. In the present invention, the cycle characteristics may be further improved by additives in some cases. The additives listed above are specifically described below.

As the halogenated cyclic carbonate, the examples thereof include a compound represented, by the following formula (B).

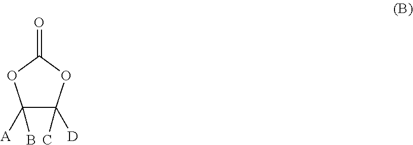

In the formula (B), A, B, C and D each independently represent a hydrogen atom, a halogen, atom, an alfcyl group or a halogenated alkyl group having 1 to 6 carbon atoms, and at least one of A, B, C and D is a halogen atom or a halogenated alkyl group. The alkyl group and the halogenated alkyl group have preferably 1 to 4 carbon atoms, and more preferably 1 to 3 carbon atoms.

In one embodiment, the halogenated cyclic carbonate is preferably a fluorinated cyclic carbonate. The examples of the fluorinated cyclic carbonates include compounds in which a part or all of the hydrogen atoms of ethylene carbonate (EC), propylene carbonate (PC), butylene carbonate (BC) and the like are substituted with fluorine atoms, and the like. Among these, 4-fluoro-1,3-dioxolan-2-one (fluoroethylene carbonate: FEC) is preferred.

The content of the fluorinated cyclic carbonate is not particularly limited, but it is preferably 0.01% by mass or more and 1% by mass or less in the electrolytic solution. When it is contained in an amount of 0.01% by mass or more, a sufficient film forming effect can be obtained. When the content is 1% by mass or less, gas generation due to decomposition of the fluorinated cyclic carbonate itself can be reduced. In the present embodiment, the content is more preferably 0.8% by mass or less. By setting the content of the fluorinated cyclic carbonate to 0.8% by mass or less, it is possible to suppress the decrease in the activity of the negative electrode active material and maintain good cycle characteristics.

Unsaturated cyclic carbonates are cyclic carbonates having at least one carbon-carbon unsaturated bond in a molecule, and the examples thereof include vinylene carbonate compounds such as vinylene carbonate, methyl vinylene carbonate, ethyl vinylene carbonate, 4,5-dimethyl vinylene carbonate, 4,5-diethyl vinylene carbonate; vinyl ethylene carbonate compounds such as 4-vinyl ethylene carbonate, 4-methyl4-vinyl ethylene carbonate, 4-ethyl-4-vinyl ethylene carbonate, 4-n-propyl-4-vinylene ethylene carbonate, 5-methyl-4-vinyl ethylene carbonate, 4,4-divinyl ethylene carbonate, 4,5-divinyl ethylene carbonate, 4,4-dimethyl-5-methylene ethylene carbonate, 4,4-diethyl-5-methylene ethylene carbonate; and the like. Among these, vinylene carbonate and 4-vinylethylene carbonate are preferable, and vinylene carbonate is particularly preferable.

The content of the unsaturated cyclic carbonate is not particularly limited, but it is preferably 0.01% by mass or more and 10% by mass or less in the electrolytic solution. When it is contained in an amount of 0.01% by mass or more, a sufficient film forming effect can be obtained. When the content is 10% by mass or less, gas generation due to decomposition of the unsaturated cyclic carbonate itself can be reduced. In the present embodiment, from the viewpoint of suppressing a decrease in the activity of the negative electrode active material, it is more preferably 5% by mass or less.

As the cyclic or open-chain disulfonic acid, esters, for example, cyclic disulfonic acid esters represented by the following formula (C) or open-chain disulfonic acid esters represented by the following formula (D) can be exemplified.

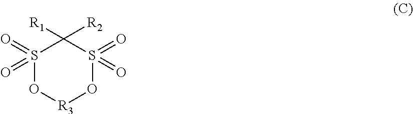

In the formula (C), R₁ and R₂, independently each other, represent a substituent selected from the group consisting of a hydrogen atom, an alkyl group having 1 to 5 carbon atoms, a halogen group, and an amino group. R₃ represents an alkylene group having 1 to 5 carbon atoms, a carbonyl group, a sulfonyl group, a fluoroalkylene group having 1 to 6 carbon atoms, or a divalent group having 2 to 6 carbon atoms in which alkylene units or fluoroalkylene units are bonded via ether group.

In formula (C), R₁ and R₂ are each independently preferably a hydrogen atom, an alkyl group having 1 to 3 carbon atoms or a halogen group, and R₃ is more preferably an alkylene group or fluoroalkylene group having 1 or 2 carbon atoms.

Preferable examples of the cyclic disulfonic acid esters represented by the formula (C) include compounds represented by the following formulae (1) to (20).

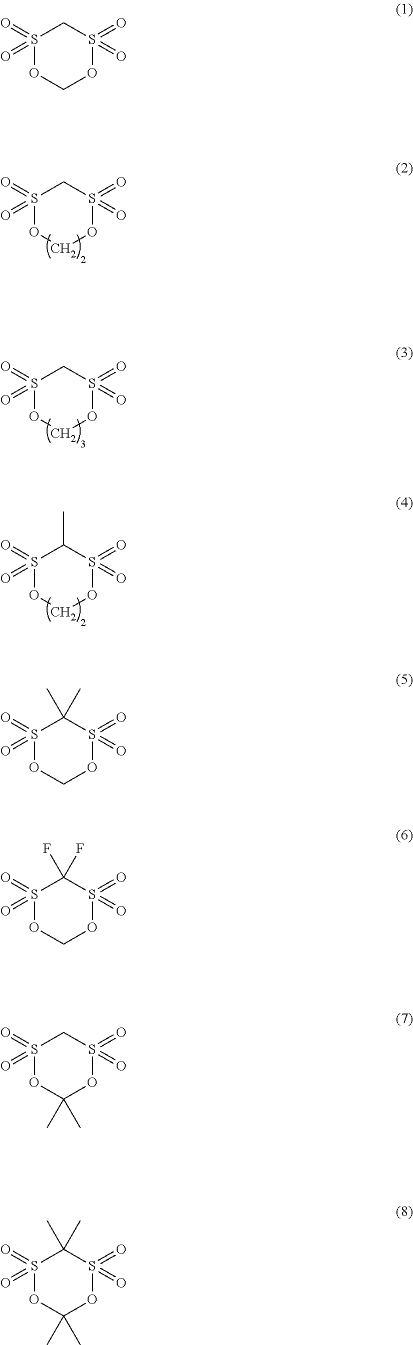

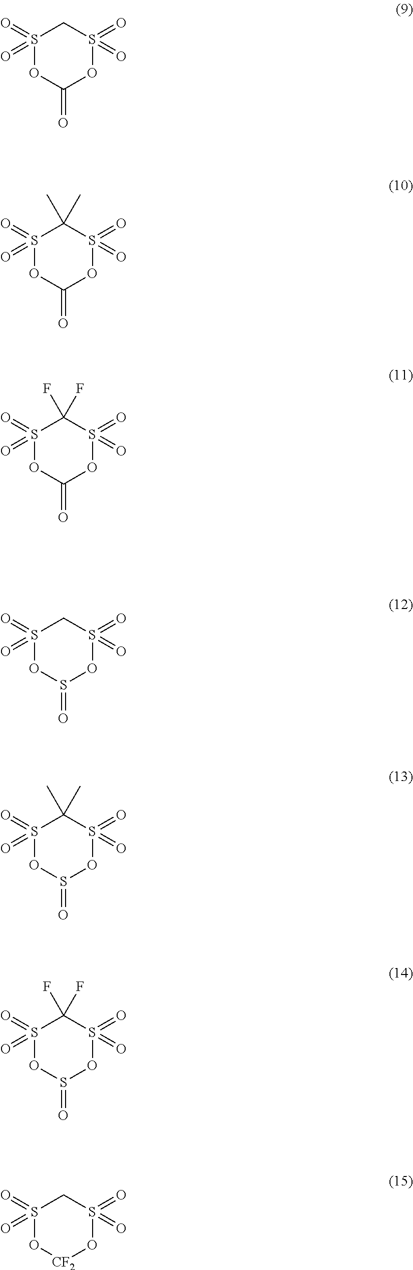

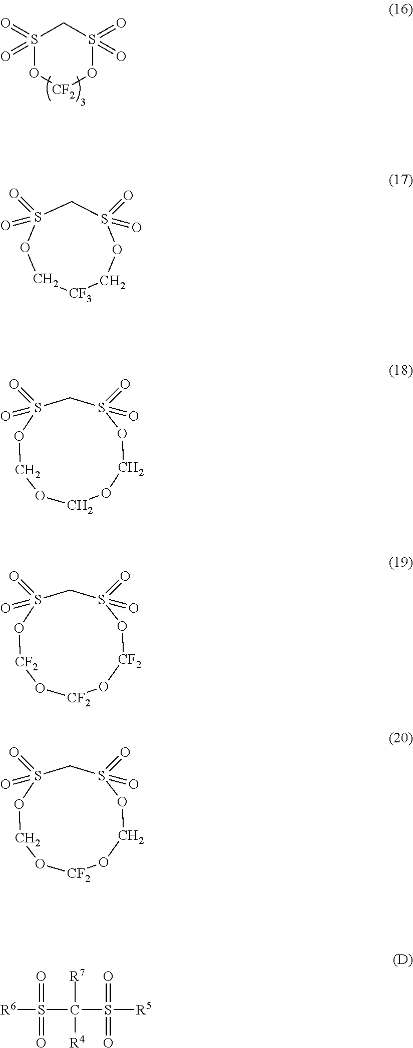

In the formula (D), R⁴ and R⁷, independently each other, represent an atom or a group selected from, the group consisting of a hydrogen atom, an alkyl group having 1 to 5 carbon atoms, an alkoxy group having 1 to 5 carbon atoms, an fluoroalkyl group having 1 to 5 carbon atoms, an polyfluoroalkyl group having 1 to 5 carbon atoms, —SO₂X₃ (X₃ is an alkyl group having 1 to 5 carbon atoms), —SY₁ (Y₁ is an alkyl group having 1 to 5 carbon atoms), —COZ (Z is a hydrogen atom or an alkyl group having 1 to 5 carbon atoms), and a halogen atom. R⁵ and R⁶, independently each other, represent an atom or a group selected from an alkyl group having 1 to 5 carbon atoms, an alkoxy group having 1 to 5 carbon atoms, a phenoxy group, a fluoroalkyl group having 1 to 5 carbon atoms, a polyfluoroalkyl group having 1 to 5 carbon atoms, a fluoroalkoxy group having 1 to 5 carbon atoms, a polyfluoroalkoxy group having 1 to 5 carbon atoms, a hydroxyl group, a halogen atom, —NX₄X₅ (X₄ and X₅ are, independently each other, a hydrogen or an alkyl group having 1 to 5 carbon atoms) or —NY₂CONY₃Y₄ (Y₂ to Y₄ are, independently each other, a hydrogen atom or an alkyl group having 1 to 5 carbon atoms).

In the formula (D), R⁴ and R⁷ are, independently each other, preferably a hydrogen atom, an alkyl group having 1 or 2 carbon atoms, a fluoroalkyl group having 1 or 2 carbon atoms, or a halogen atom, and R⁵ and R⁶, independently each other, represent an alkyl group having 1 to 3 carbon atoms, an alkoxy group having 1 to 3 carbon atoms, a fluoroalkyl group having 1 to 3 carbon atoms, a polyfluoroalkyl group having 1 to 3 carbon atoms, a hydroxyl group or a halogen atom.

Preferred compounds of the open-chain disulfonic acid ester compound represented by the formula (D) include, for example, the following compounds.

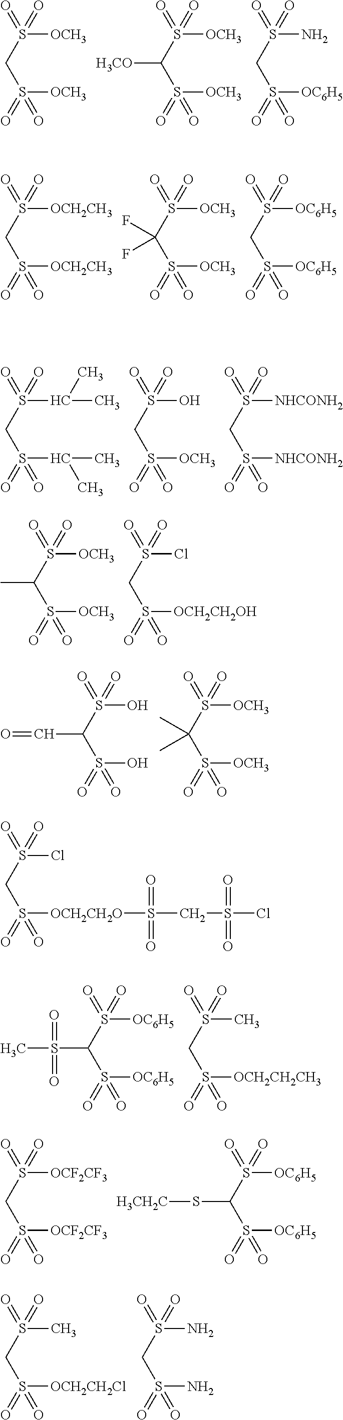

The content of the cyclic or open-chain disulfonic acid ester is preferably 0.005 mol/L or more and 10 mol/L or less, more preferably 0.01 mol/L or more and 5 mol/L or less in the electrolyte solution, and particularly preferably 0.05 mol/L or more and 0.15 mol/L or less. When it is contained in an amount of 0.005 mol/L or more, a sufficient film forming effect can be obtained. When the content is 10 mol/L or less, it is possible to suppress an increase in the viscosity of the electrolyte solution and the resulting increase in resistance.

Additives may be used alone or in combination of two or more. When two or more kinds of additives are used in combination, the total content of the additives is preferably 10% by mass or less, more preferably 5% by mass or less in the electrolyte solution.

<Separator>

The separator may be of any type as long as it suppresses electron conduction between the positive electrode and the negative electrode, does not inhibit the permeation of charged substances, and has durability against the electrolyte solution. Specific examples of the material include polyolefins such, as polypropylene and polyethylene; cellulose, polyethylene terephthalate, polyimide, polyvinylidene fluoride; and aromatic polyamides such as polymetaphenylene isophthalamide, polyparaphenylene terephthalamide and copolyparaphenylene 3,4′-oxydiphenylene terephthalamide; and the like. These can be used as porous films, woven fabrics, nonwoven fabrics and the like.

<Secondary Battery>

In the lithium ion secondary battery according to the present embodiment, an electrode body in which at least a pair of a positive electrode and a negative electrode are opposed to each other and an electrolyte solution are contained in the outer package. The shape of the secondary battery may be any one of cylindrical type, flat spirally wound prismatic type, stacked square shape type, coin type, flat wound laminated type and stacked laminate type, but stacked laminate type is preferred. Hereinafter, a stacked laminate type secondary battery will be described.

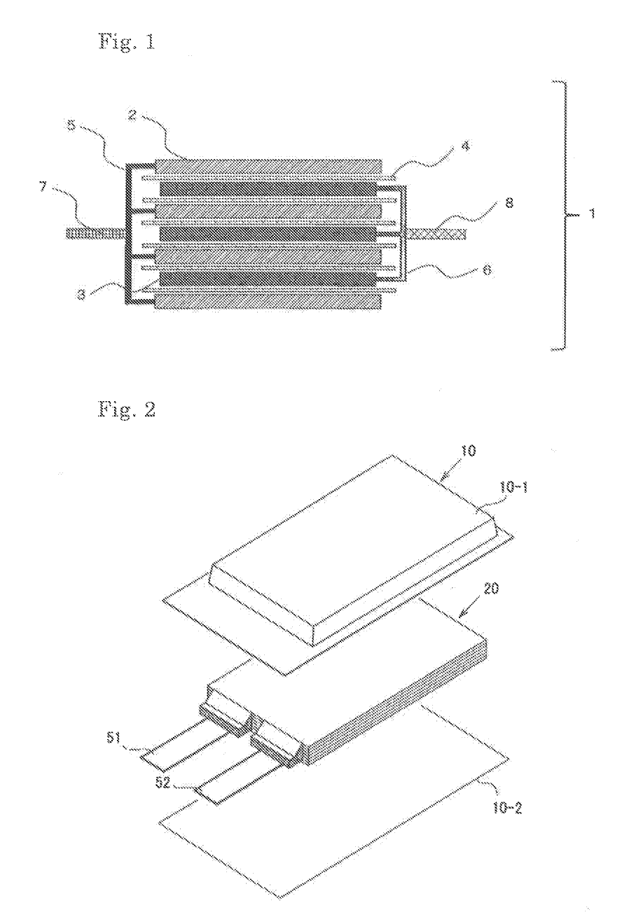

FIG. 1 is a schematic sectional view of an example of a stacked electrode element 1 of a stacked laminate type secondary battery. A plurality of positive electrodes 2 and a plurality of negative electrodes 3 are alternately stacked with separators 4 sandwiched therebetween. At each end of each positive electrode 2 and each negative electrode 3, active material uncoated portions are provided, where a positive electrode current collector 5 and a negative electrode current collector 6 are not covered with the active materials. The positive electrode 2 and the negative electrode 3 are stacked with the active material uncoated portions in opposite directions to each other.

The positive electrode current collectors 5 are electrically connected to each other at the active material uncoated portions, and a positive electrode lead terminal 7 is further connected to the connection portion. The negative electrode current collectors 6 are electrically connected to each other at the active material uncoated portion, and a negative electrode lead terminal 8 is further connected to the connection portion.

A stacked laminate type secondary battery is produced by enclosing the laminated electrode element 1 with an outer package such as an aluminum laminate film, injecting an electrolyte solution, and sealing it under a reduced pressure.

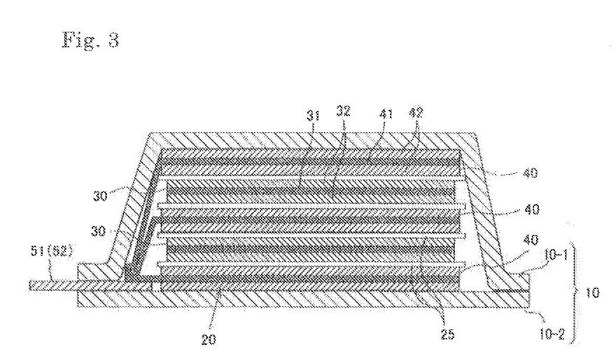

As another embodiment, a secondary battery having a structure as shown in FIG. 2 and FIG. 3 may be provided. This secondary battery comprises a battery element 20, a film package 10 housing the battery element 20 together with an electrolyte, and a positive electrode tab 51 and a negative electrode tab 52 (hereinafter these are also simply referred to as “electrode tabs”).

In the battery element 20, a plurality of positive electrodes 30 and a plurality of negative electrodes 40 are alternately stacked with separators 25 sandwiched therebetween as shown in FIG. 3. In the positive electrode 30, an electrode material 32 is applied to both surfaces of a metal foil 31, and also in the negative electrode 40, an electrode material 42 is applied to both surfaces of a metal foil 41 in the same manner.

In the secondary battery in FIG. 1, the electrode tabs are drawn out on both sides of the package, but a secondary battery to which the present invention may be applied may have an arrangement in which the electrode tabs are drawn out on one side of the package as shown in FIG. 2. Although detailed illustration is omitted, the metal foils of the positive electrodes and the negative electrodes each have an extended portion in part of the outer periphery. The extended portions of the negative electrode metal foils are brought together into one and connected to the negative electrode tab 52, and the extended portions of the positive electrode metal foils are brought together into one and connected to the positive electrode tab 51 (see FIG. 3). The portion in which the extended portions are brought together into one in the stacking direction in this manner is also referred to as a “current collecting portion” or the like.

The film package 10 is composed of two films 10-1 and 10-2 in this example. The films 10-1 and 10-2 are heat-sealed to each other in the peripheral portion of the battery element 20 and hermetically sealed. In FIG. 3, the positive electrode tab 51 and the negative electrode tab 52 are drawn out in the same direction from one short side of the film package 10 hermetically sealed in this manner.

Of course, the electrode tabs may be drawn out from different two sides respectively. In addition, regarding the arrangement of the films, in FIG. 2 and FIG. 3, an example in which a cup portion is formed In one film 10-1 and a cup portion is not formed in the other film 10-2 is shown, hut other than this, an arrangement in which cup portions are formed in both films (not illustrated), an arrangement in which a cup portion is not formed in either film (not illustrated), and the like may also be adopted.

<Method for Producing Lithium Ion Secondary Battery>

The lithium ion secondary battery according to the present embodiment can be manufactured according to conventional method. An example of a method for manufacturing a lithium ion secondary battery will be described taking a stacked laminate type lithium ion secondary battery as an example. First, in the dry air or an inert atmosphere, the positive electrode and the negative electrode are placed to oppose to each other via a separator to form the above-mentioned electrode element. Next, this electrode element is accommodated in an outer package (container), an electrolyte solution is injected, and the electrode is impregnated with, the electrolyte solution. Thereafter, the opening of the outer package is sealed to complete the lithium ion secondary battery.

<Assembled Battery>

A plurality of lithium ion secondary batteries according to the present embodiment may be combined to form an assembled battery. The assembled battery may be configured by connecting two or more lithium ion secondary batteries according to the present embodiment in series or in parallel or in combination of both. The connection in series and/or parallel makes it possible to adjust the capacitance and voltage freely. The number of lithium ion secondary batteries included in the assembled battery can be set appropriately according to the battery capacity and output.

<Vehicle>

The lithium ion secondary battery or the assembled battery according to the present embodiment can be used in vehicles. Vehicles according to an embodiment of the present invention include hybrid vehicles, fuel cell vehicles, electric vehicles (besides four-wheel vehicles (cars, trucks, commercial vehicles such as buses, light automobiles, etc.) two-wheeled vehicle (bike) and tricycle), and the like. The vehicles according to the present embodiment is not limited to automobiles, it may be a variety of power source of other vehicles, such as a moving body like a train.

<Power Storage Equipment>

The lithium ion secondary battery or the assembled battery according to the present embodiment can be used in power storage system. The power storage systems according to the present embodiment include, for example, those which is connected between the commercial power supply and loads of household appliances and used as a backup power source or an auxiliary power in the event of power outage or the like, or those used as a large scale power storage that stabilize power output with large time variation supplied by renewable energy, for example, solar power generation.

### EXAMPLE

Next, the present embodiment will be specifically described with reference to examples. The following examples illustrate preferred modes of this embodiment, and the present invention is not limited to the following examples.

### Example 1

(Adjustment of Circularity of SiO and Measurement)

SiO (catalog No. SIO 02PB made by Kojundo Chemical Laboratory Co., Ltd., 75 μm mesh-passed product) was pulverized using a planetary ball mill (Classic Line P-5 manufactured by Fritsch) to adjust the particle size distribution and circularity. The median diameter (d50) of the SiO particles after adjustment and the circularity of 500 SiO particles were measured with a powder measuring device (Seishin Enterprise Co., LTD.: PITA-3). Table 1 shows average values of d50 and circularity.

(Preparation of Surface-Coated Carbon Material)

Flake-like natural graphite was processed into a spherical shape using Faculty F-430S (manufactured by Hosokawa Micron Corporation), and its surface was covered with amorphous carbon using CVD. The coating amount of amorphous carbon was adjusted to be 3% of the total.

(Preparation of Negative Electrode)

SiO, surface-coated carbon material and a mixed solution of polyamic acid and N-methyl-2-pyrrolidone (NMP) (trade name: U-Varnish Ube Industries, Ltd.) were mixed so that a mass ratio is 8.5:76.5:15 (mass of solid content for polyamic acid solution), and N-methylpyrrolidone (NMP) was further added to adjust the viscosity, to obtain a slurry. This slurry was applied to a copper foil having a thickness of 10 μm with a doctor blade and then dried by heating at 130° C. for 7 minutes. Thereafter, the obtained negative electrode was heated in vacuum at 180° C. for 15 minutes to imidize the polyamic acid, thereby completing the formation of the negative electrode.

(Preparation of Positive Electrode)

Lithium nickelate, carbon black (trade name: “#3030 B”, manufactured by Mitsubishi Chemical Corporation), and polyvinylidene fluoride (trade name: “W #7200”, manufactured by Kureha Corporation) were respectively weighed to have a mass ratio of 95:2:3. These were mixed with NMP to prepare a slurry. The mass ratio of NMP and solid content was 54:48. This slurry was applied to an aluminum foil having a thickness of 15 μm using a doctor blade. The aluminum foil coated with this slurry was heated at 120° C. for 5 minutes to dry NMP to prepare a positive electrode.

(Assembly of Secondary Battery)

An aluminum terminal and a nickel terminal were welded to the fabricated positive electrode and negative electrode, respectively. These were superimposed via a separator to prepare an electrode element. The electrode element was packaged with a laminate film, and an electrolyte solution was injected into the laminate film. Thereafter, the laminate film was thermally fusion-bonded for sealing while reducing the pressure inside of the laminate film. In this way, a plurality of flat-type secondary batteries before the first charge were prepared. A polypropylene film was used as the separator. As the laminate film, a polypropylene film with vapor-deposited aluminum was used. For the electrolyte solution, a solution containing 1.0 mol/l of LiPF₆ as an electrolyte and a mixed solvent of propylene carbonate, ethylene carbonate and diethyl carbonate (0.5:6.5:3 (volume ratio)) as a nonaqueous electrolyte solvent was used.

(Charge/Discharge Cycle Test of Secondary Battery)

The prepared secondary battery was subjected to a charge/discharge cycle test in a thermostat oven maintained, at 45° C. The battery voltage was set in the range of 3.0 to 4.2 V, charging was performed by CCCV method, and after the voltage reached 4.2 V, the voltage was kept constant for one hour. Discharge is performed by CC method (Constant current 1.0 C). Here, 1.0 C current means a current which takes 1 hour until completely discharging a battery in an arbitrary fully charged state when discharging the battery at the constant current. Table 1 shows the number of charge/discharge cycles at which the discharge capacity became 70% or less of the initial capacity.

### Example 2

A secondary battery was prepared in the same manner as in Example 1 except that the particle size and the circularity of SiO after pulverization in Example 1 were adjusted as shown in Table 1, and a charge/discharge cycle test was carried out.

### Example 3

A secondary battery was prepared in the same manner as in Example 1 except that the particle size and the circularity of SiO after pulverization in Example 1 were adjusted as shown in Table 1, and a charge/discharge cycle test was carried out.

### Example 4

A secondary battery was prepared in the same manner as in Example 1 except that Si (manufactured by Kojundo Chemical Laboratory Co., Ltd., Catalog No. SIE 07 PB, 300 μm or less) was used in place of SiO in Example 1, and a charge/discharge cycle test was carried out.

### ExampIe 5

A secondary battery was prepared in the same manner as in Example 1 except that SnO (catalog No. SNO 01 PB, manufactured by Kojundo Chemical Laboratory Co., Ltd.) was used in place of SiO in Example 1, and a charge/discharge cycle test was carried out.

### Comparative Example 1

A secondary battery was prepared in the same manner as in Example 1 except that the particle size and the circularity of SiO after pulverization in Example 1 were adjusted as shown in Table 1, and a charge/discharge cycle test was carried out.

### Comparative Example 2

A secondary battery was prepared in the same manner as in Example 1 except that the particle size and the circularity of Si after pulverization in Example 4 were adjusted as shown in Table 1, and a charge/discharge cycle test was carried out.

### Comparative Example 3

A secondary battery was prepared in the same manner as in Example 1 except that the particle size and the circularity of SnO after pulverization in Example 5 were adjusted as shown in Table 1, and a charge/discharge cycle test was carried out.

### Comparative Example 4

A secondary battery was prepared, in the same manner as in Example 1 except that spheroidized natural graphite without surface coating by CVD was used in place of the surface coated carbon material in Example 1, and a charge/discharge cycle test was carried out.

TABLE 1

| | non-carbon | | | | |
|---|---|---|---|---|---|
| | negative- | | | | |
| | electrode | D50 | average | carbon | cycle |
| | material | (μm) | circularity | material | number |
| Example 1 | SiO | 5.4 | 0.93 | with surface | 353 |
| | | | | coating | |
| Example 2 | SiO | 6.4 | 0.85 | with surface | 321 |
| | | | | coating | |
| Example 3 | SiO | 5.7 | 0.80 | with surface | 309 |
| | | | | coating | |
| Example 4 | Si | 3.8 | 0.87 | with surface | 194 |
| | | | | coating | |
| Example 5 | SnO | 7.4 | 0.91 | with surface | 289 |
| | | | | coating | |
| Comparative | SiO | 5.8 | 0.73 | with surface | 123 |
| Example 1 | | | | coating | |
| Comparative | Si | 5.2 | 0.71 | with surface | 82 |
| Example 2 | | | | coating | |
| Comparative | SnO | 7.1 | 0.75 | with surface | 131 |
| Example 3 | | | | coating | |
| Comparative | SiO | 5.4 | 0.84 | no surface | 178 |
| Example 4 | | | | coating | |

### INDUSTRIAL APPLICABILITY

The battery provided by the present invention can be utilized in all the industrial fields requiring a power supply and the industrial fields pertaining to the transportation, storage and supply of electric energy. Specifically, it can be used in, for example, power supplies for mobile equipment; power supplies for moving/transporting media; backup power supplies; and electricity storage facilities for storing electric power generated by photovoltaic power generation, wind power generation and the like.

### EXPLANATION OF SYMBOLS

1 stacked electrode element
2 positive electrode
3 negative electrode
4 separator
5 positive electrode current collector
6 negative electrode current collector
7 positive lead terminal
8 negative electrode lead terminal
10 film package
20 battery element
25 separator
30 positive electrode
40 negative electrode

1. A negative electrode for a lithium ion secondary battery, comprising, as active materials, (a) at least one material selected from metals capable of forming an alloy with lithium and metal oxides capable of absorbing and desorbing lithium ions (hereinafter referred to as metal and/or metal oxide), and
(b) a surface-coated carbon material capable of absorbing and desorbing lithium ions,
wherein, an average value of circularity of the metal and/or metal oxide particles defined by following formula (1):
Circularity=4πS/L² (1)
wherein S is an area of a projected image of particle and L is a
circumferential length of the projected image of particle;
is 0.78 or more.

2. The negative electrode for a lithium ion secondary battery according to claim 1, wherein at least Si and/or silicon oxide is contained as the metal and/or metal oxide.

3. The negative electrode for a lithium ion secondary battery according to claim 1, wherein the surface-coated carbon material is an amorphous carbon-coated graphite.

4. The negative electrode for a lithium ion secondary battery according to claim 1, wherein the median diameter of (a) the metal and/or metal oxide particles is 1 to 30 μm, the median diameter of (b) the surface-coated carbon material particles is 5 to 50 μm and the median diameter of the metal and/or metal oxide particles is smaller than the median diameter of the surface-coated carbon material.

5. The negative electrode for a lithium ion secondary battery according to claim 1, wherein a ratio of (a) the metal and/or metal oxide and (b) the surface-coated carbon material is in the range of 1:99 to 20:80.

6. A lithium ion secondary battery comprising at least the negative electrode for a lithium ion secondary battery according to claim 1, a positive electrode, and an electrolyte solution.

7. (canceled)

8. (canceled)

9. A method of manufacturing a negative electrode for a lithium ion secondary battery, comprising the steps of:
(i) preparing a negative electrode slurry by kneading:
(a) at least one material selected from metals capable of forming an alloy with lithium and metal oxides capable of absorbing and desorbing lithium ions (hereinafter referred to as metal and/or metal oxide),
(b) a surface-coated carbon material capable of absorbing and desorbing lithium ions, and
(c) a binder in a solvent, and
(ii) applying the prepared negative electrode slurry on a negative electrode current collector and drying the solvent to form a negative electrode layer.

10. (canceled)
